(19) United States
(12) Patent Application Publication
(10) Pub. No.: US 2024/0361478 A1
(43) Pub. Date: Oct. 31, 2024

(54) SYSTEMS AND METHODS FOR IONOSPHERIC CHARACTERIZATION USING HIGH FREQUENCY SIGNALS

(71) Applicant: Atmospheric & Space Technology Research Associates, L.L.C. dba Orion Space Solutions, Louisville, CO (US)

(72) Inventors: Joseph HUGHES, Arvada, CO (US); Ryan BLAY, Broomfield, CO (US); Ian COLLETT, Commerce City, CO (US); Geoffrey CROWLEY, Lafayette, CO (US)

(73) Assignee: Atmospheric & Space Technology Research Associates, L.L.C. dba Orion Space Solutions, Louisville, CO (US)

(21) Appl. No.: 18/648,282

(22) Filed: Apr. 26, 2024

Related U.S. Application Data
(60) Provisional application No. 63/462,630, filed on Apr. 28, 2023.

(51) Int. Cl. G01T 1/29; G01S 19/07; H04B 7/22

(52) U.S. Cl. CPC G01T 1/2935; G01S 19/072; H04B 7/22

(57) ABSTRACT

A method for determining an electron density in a portion of an ionosphere includes: receiving, at a satellite in orbit, a signal transmitted from a ground-based transmitter through a portion of the ionosphere between the satellite and the ground transmitter; receiving, at the satellite, a reflection of the signal from a portion of the ionosphere above the satellite; and determining, based on the signal received at the satellite transmitted from the ground-based transmitter through the portion of the ionosphere between the satellite and the ground-based transmitter and the reflection of the signal received from the portion of the ionosphere above the satellite, an electron density of the portion of the ionosphere above the satellite.

### CROSS-REFERENCE TO RELATED APPLICATIONS

This application claims the benefit of U.S. Provisional Application No. 63/462,630, filed Apr. 28, 2023, the entire contents of which are hereby incorporated by reference herein.

### FIELD

This disclosure relates generally to remote sensing instruments and more specifically to remote sensing instruments for monitoring and characterizing the ionosphere using high frequency signals.

### BACKGROUND

The ionosphere plays a major role in society via its impact on communications, navigation, and many other operations. The ionosphere can affect radio systems at all frequencies, either through large or small-scale variation of the electron density. Large scale variations can cause the ionosphere to not support High-Frequency radio communications at certain frequencies and even small-scale irregularities can disrupt communications and degrade Global Navigation Satellite System (GNSS) positioning. Thus, systems and methods for more efficient and comprehensive characterization of the ionosphere are desirable.

### SUMMARY

Described herein are systems, devices, methods, and non-transitory computer readable storage media for ionospheric monitoring and analysis. The techniques described herein enable characterization of the ionosphere both above and below a satellite using a signal received at the satellite from a ground-based transmitter. An exemplary satellite system implementing the techniques described herein may receive (a) signal(s) directly from the ground-based transmitter (referred to herein as direct signals or direct rays) that enable characterization of a portion of the ionosphere between the satellite and the ground-based transmitter, and (b) reflections of those signal(s) (referred to herein as reflected signals or reflected rays) reflected from a portion of the ionosphere above the satellite that enable characterization of a portion of the ionosphere above the satellite.

An exemplary system may receive, at a satellite in orbit, a signal transmitted from a ground-based transmitter through a portion of the ionosphere between the satellite and the ground-based transmitter. The system may then receive a reflection of the signal from a portion of the ionosphere above the satellite. Because the reflection of the signal must travel further than the direct signal (e.g., past the satellite into a portion of the ionosphere above the satellite and then back down to the satellite), there is a period of time between receipt of the direct signal and the reflection of the signal. The system may determine the electron density of the portion of the ionosphere above the satellite based on the amount of time between the receipt of the direct signal and the reflection of the signal. In some examples, the system may also determine a total electron content of the portion of the ionosphere between the satellite and the ground-based transmitter based on a delay of the direct signal. Based on the electron density and/or TEC, the system may predict effects of the ionosphere on one or more signals to dynamically alter characteristics of signals utilized in communications systems, navigation systems, etc.

An exemplary method for determining an electron density in a portion of an ionosphere comprises: receiving, at a satellite in orbit, a signal transmitted from a ground-based transmitter through a portion of the ionosphere between the satellite and the ground transmitter; receiving, at the satellite, a reflection of the signal from a portion of the ionosphere above the satellite; and determining, based on the signal received at the satellite transmitted from the ground-based transmitter through the portion of the ionosphere between the satellite and the ground-based transmitter and the reflection of the signal received from the portion of the ionosphere above the satellite, an electron density of the portion of the ionosphere above the satellite.

In some examples, the electron density of the portion of the ionosphere above the satellite is determined by computing a virtual height between the satellite and an altitude at which the signal reflected by the ionosphere; and inverting the virtual height to determine the electron density at the altitude.

In some examples, the virtual height is computed by multiplying one half of an amount of time between receiving the signal and receiving the reflection of the signal by the speed of light.

In some examples, the method comprises determining, based on a delay of the signal received through the portion of the ionosphere between the satellite and the ground transmitter, a total electron content (TEC) of the portion of the ionosphere between the satellite and the ground transmitter.

In some examples, determining at least one of the TEC and the electron density comprises using ray tracing to quantify an impact of at least one of non-specular reflection and earth's magnetic field on the signal and the reflection of the signal.

In some examples, determining at least one of the TEC and the electron density comprises determining an impact of a doppler shift on the signal and the reflection of the signal.

In some examples, the signal comprises a plurality of frequencies between 3 and 30 MHz transmitted over a period of time.

In some examples, the method comprises: for each frequency of the plurality of frequencies, determining a virtual height between the satellite and an altitude at which the respective frequency was reflected by the ionosphere; and inverting the virtual height to determine the electron density at the altitude at which the respective frequency was reflected.

In some examples, the method comprises: determining an electron density profile (EDP) based on the electron density determined for each frequency.

In some examples, the portion of the ionosphere between the satellite and the ground-based transmitter comprises at least one of a portion of the E layer of the ionosphere and a portion of the F layer of the ionosphere.

In some examples, the portion of the ionosphere above the satellite comprises a portion of the F layer of the ionosphere.

In some examples, the satellite is positioned in very low earth orbit (VLEO).

In some examples, the satellite is positioned below a height of a peak electron density of the F2 layer of the ionosphere.

In some examples, the signal transmitted from the ground-based transmitter is transmitted from less than 5,000 km from the satellite.

In some examples, the method comprises predicting an effect on at least one of the signal transmitted from the ground-based transmitter and a signal other than the signal transmitted from the ground-based transmitter based on at least one of the TEC and the EDP.

In some examples, the method comprises adjusting a characteristic of at least one of the signal transmitted from the ground-based transmitter and the signal other than the signal transmitted from the ground-based transmitter based on the predicted effect, wherein the characteristic comprises at least one of a frequency, a wavelength, an amplitude, a polarization, a transmission power, and a bandwidth.

In some examples, the method comprises generating a model of at least a portion of the ionosphere based on the electron density.

In some examples, the method comprises transmitting the signal from the ground-based transmitter.

An exemplary non-transitory computer readable storage medium stores instructions for determining an electron density in a portion of an ionosphere wherein the instructions are executable by a system comprising one or more processors to cause the system to: receive, at a satellite in orbit, a signal transmitted from a ground-based transmitter through a portion of the ionosphere between the satellite and the ground transmitter; receive, at the satellite, a reflection of the signal from a portion of the ionosphere above the satellite; and determine, based on the signal received at the satellite transmitted from the ground-based transmitter through the portion of the ionosphere between the satellite and the ground-based transmitter and the reflection of the signal received from the portion of the ionosphere above the satellite, an electron density of the portion of the ionosphere above the satellite.

An exemplary system comprises one or more processors and a memory storing one or more computer programs that include computer instructions, which when executed by the one or more processors, cause the system to: receive, at a satellite in orbit, a signal transmitted from a ground-based transmitter through a portion of the ionosphere between the satellite and the ground transmitter; receive, at the satellite, a reflection of the signal from a portion of the ionosphere above the satellite; and determine, based on the signal received at the satellite transmitted from the ground-based transmitter through the portion of the ionosphere between the satellite and the ground-based transmitter and the reflection of the signal received from the portion of the ionosphere above the satellite, an electron density of the portion of the ionosphere above the satellite.

An exemplary system comprises: a satellite; at least one receiver positioned on the satellite; and one or more processors and a memory, the memory storing one or more computer programs that include computer instructions, which when executed by the one or more processors, cause the system to: determine, based on a signal received at the receiver positioned on the satellite, the signal transmitted from a ground-based transmitter through a portion of the ionosphere between the satellite and the ground-based transmitter, and a reflection of the signal received from a portion of the ionosphere above the satellite, an electron density of the portion of the ionosphere above the satellite.

In some examples, the one or more processors are located at a ground station.

In some examples, the one or more processors are positioned on the satellite.

In some examples, the ground-based transmitter comprises an ionosonde.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for determining an electron density, total electron content (TEC), and/or electron density profile (EDP) of a portion of the ionosphere according to some embodiments.

FIG. 2A illustrates an exemplary satellite system for determining electron density, TEC, and/or an EDP of a portion of the ionosphere and an ionospheric profile that depicts approximate electron density by altitude according to some embodiments.

FIG. 2B illustrates a graph depicting a virtual height between a direct signal and a reflected signal of a swept signal according to some embodiments.

FIG. 2C illustrates a satellite system in an exemplary environment according to some

embodiments.

FIG. 3 illustrates an exemplary method for determining an electron density, total electron content (TEC), and/or electron density profile (EDP) of a portion of the ionosphere according to some embodiments.

FIG. 4A illustrates an exemplary signal path according to some embodiments.

FIG. 4B illustrates an impact of off-vertical transmission geometry of an exemplary signal path according to some embodiments.

FIG. 5A illustrates a graph showing results of an exemplary TEC computation according to some embodiments.

FIG. 5B illustrates a graph showing effects of a magnetic field on a signal according to some embodiments.

FIG. 6 illustrates an exemplary computing device according to some embodiments.

### DETAILED DESCRIPTION

Described herein are systems, devices, methods, and non-transitory computer readable storage media for ionospheric monitoring and analysis. The ionosphere is a region of space from approximately 100 to 1,000 km in altitude where the atmosphere is electrically charged. The electron density in the ionosphere varies with altitude. It reaches a maximum in the F2 region at an altitude known as ‘hmF2’ which is typically between 250 and 400 km depending on the place and time. An exemplary satellite system may be positioned in orbit such that it is located below hmF2. The satellite system may receive signals transmitted from a ground-based transmitter both directly through a portion of the ionosphere below the satellite and reflected from a portion of the ionosphere above the satellite. Based on the directly received signals and the reflections of those signals, the systems described herein may characterize different portions of the ionosphere (e.g., by determining electron density and/or total electron content) as the satellite moves in orbit around the planet. The systems described herein may be implemented using transmission and reception equipment provided on existing satellites, may be retrofitted onto an existing satellite, and/or may be implemented as a specialized (e.g., standalone) satellite.

In some examples, an exemplary satellite system may be configured to determine the electron density above the satellite but below hmF2. The satellite system may also be configured to determine the total electron content (TEC) between the satellite and the transmitter. Total electron content is defined as the line integral between two points of the electron density integrated with respect to distance. To calculate the electron density above the satellite but below hmF2, the system may determine a virtual height between the satellite and an altitude at which the signal was reflected by the ionosphere. The virtual height is defined as one half of the amount of time between receiving the signal transmitted through the portion of the ionosphere between the ground-based transmitter and the satellite and receiving the reflection of the signal by the speed of light. The virtual height may correspond to the apparent height/altitude at which the signal was reflected relative to the satellite and may be used to determine the electron density. The electron density can be determined based on the variation of virtual height with frequency. This pair of variables can be transformed (e.g., using an inversion function) to produce the electron density as a function of altitude.

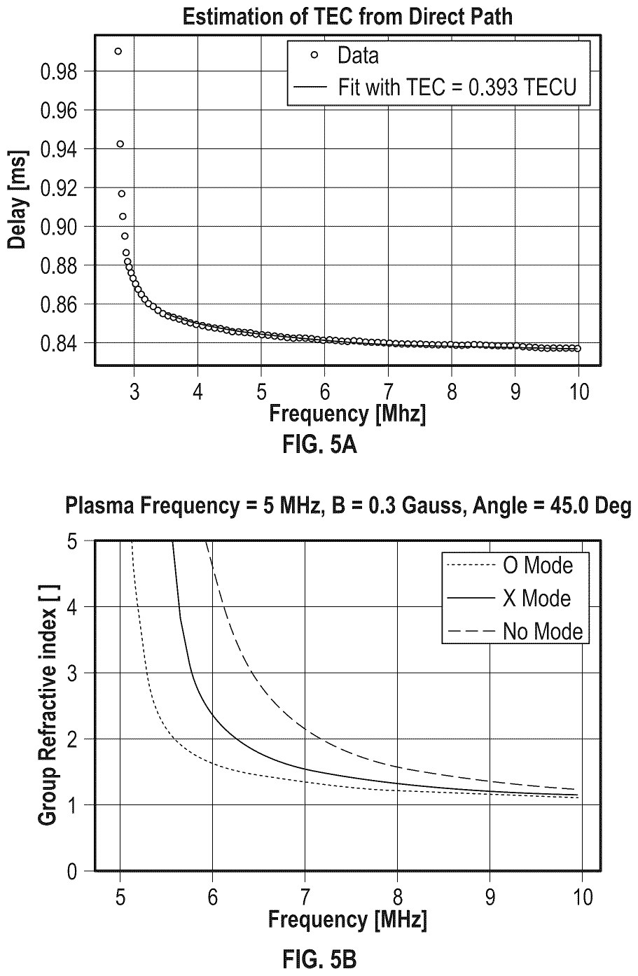

In some examples, an exemplary satellite system may be configured to determine a total electron content (TEC) based on a delay of the direct signal (the signal received directly from the ground-based transmitter through the portion of the ionosphere between the satellite and the ground-based transmitter) with frequency (e.g., as shown in FIG. 5A).

In some examples, the exemplary systems described herein may determine an electron density at a number of different altitudes above the satellite to determine an electron density profile (EDP) of a portion of the ionosphere above the satellite (e.g., between the satellite and hmF2). For instance, a ground-based transmitter may transmit a swept signal including a plurality of different frequencies over a predefined time period (e.g., 100 ms, 1 second, 5 seconds, 10 seconds, 15 minutes, or any other period of time). Different frequencies will be reflected at different altitudes of the ionosphere (e.g., high frequency signals will travel further into the ionosphere before reflection than low frequency signals). For each frequency of the swept signal, the system may determine a virtual height between the satellite and an altitude at which the respective frequency was reflected by the ionosphere. The system may invert the virtual height to determine the electron density at the altitude at which the respective frequency was reflected and determine an electron density profile based on the electron density determined for each frequency.

In some examples, the exemplary systems described herein may be configured to predict ionospheric effects on signals (e.g., communications signals, navigation signals, the signals transmitted by the ground-based transmitters described herein) based on TEC, electron density, and/or electron density profiles determined according to the methods described herein. The systems may adjust signal characteristics based on the predicted effect, including signal frequency, wavelength, amplitude, polarization, transmission power, bandwidth, and so on. Such adjustments may be made in real time in response to continuous monitoring and analysis of the ionosphere according to the systems and methods described herein. That is, the techniques described herein may iteratively/continuously characterize (e.g., determine TEC, electron density, electron density profiles) different portions of the ionosphere as the satellite moves in orbit around the earth. TEC, electron density, and/or electron density profiles determined according to the techniques described herein may be used to model the ionosphere in real time (e.g., continuously or periodically at predefined intervals), and thus various communications systems, navigation systems, and so on may utilize the models generated according to the techniques described herein to enable improved signal transmission reliability and efficiency.

The time of transmission is not required to calculate the TEC or the EDP between the satellite and below hmF2. The method described herein is similar to a conventional ground-based oblique ionogram but differs in that that the receiver of signals transmitted into the ionosphere is positioned on a satellite in orbit (e.g., very-low-earth-orbit), rather than a ground-based receiver, and the time of transmission is not needed because the direct signal provides a baseline. Because the receiver is on a satellite, measurements can be obtained anywhere a satellite has a line of sight to a HF transmitter, including over the open ocean.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

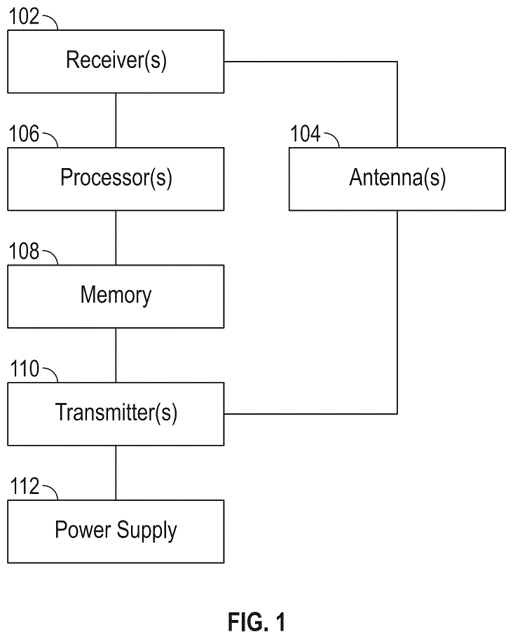

FIG. 1 illustrates an exemplary system 100 for determining an electron density, total electron content (TEC), and/or electron density profile (EDP) of a portion of the ionosphere. In some examples, system 100 includes at least one receiver 102, at least one transmitter 110, a memory 108, and one or more processors 106 connected to one or more antennas 104 and a power supply 112. In some examples, each of the components of system 100 described above are provided on a satellite or other spacecraft. In some examples, at least the at least one transmitter 110, at least one receiver 102, one or more antennas 104, and power supply 112 are provided on the same satellite or spacecraft. Power supply 110 is configured to provide sufficient power to the components of system 100 for determining electron density, TEC, and/or EDP of a portion of the ionosphere. In some examples, one or more of the components may be located remotely (e.g., on land). For instance, one or more of the one or more processors 106 may not be provided on the satellite but may instead be located at a remote ground station. In some examples, the remote ground station is in wireless communication with the satellite. In some examples, one or more of the one or more processors 106 may be part of a cloud computing system, and any of the techniques described herein may be performed, at least in part, on the cloud. Accordingly, system 100 may include various distributed components forming a distributed computing system for determining the electron density, TEC, and/or EDP of a portion of the ionosphere.

The at least one receiver 102 may be any RF receiver capable of receiving HF signals transmitted, including signals transmitted by a transmitter from the surface of a planet (e.g., from a ground-based transmitter positioned on Earth's surface). Receiver 102 may include any number of reception channels. For instance, multiple receivers may each be configured to receive a signal at a unique frequency. In some examples, one receiver including multiple reception channels may be configured to receive one or more signals at different frequencies. In some examples, multiple receivers may each be configured to receive one or more signals at a plurality of frequencies. An example of a receiver that may be included on system 100 is the e-POP radio receiver instrument described in James, H. G., King, E. P., White, A. et al. The e-POP Radio Receiver Instrument on CASSIOPE. Space Sci Rev 189, 79-105 (2015). https://doi.org/10.1007/s11214-014-0130-y, which is incorporated herein by reference in its entirety. The at least one transmitter 110 may be any RF transmitter or other transmitter capable of transmitting signals through at least a portion of the ionosphere to a planet's surface. An example of this type of transmitter would be an ionosonde; although other transmitters may be used. The at least one transmitter 110 may include any number of transmission channels. The transmitter may be configured to transmit data (e.g., electron density data, TEC data, EDP data, scintillation data) from the satellite to a receiver provided at a ground-station. In some examples, the at least one transmitter 110 and at least one receiver 102 are provided on the same component of system 100 (e.g., a transceiver). The at least one transmitter 110 and at least one receiver 102 are communicatively coupled to one or more antennas 104 for transmission and reception of HF signals.

The one or more antennas 104 may include any RF antenna capable of receiving HF signals in orbit (including very low earth orbit (VLEO)) transmitted from a transmitter on a planet's surface through at least a portion of the ionosphere (including direct and reflected signals) and/or transmitting signals to the planet's surface through at least a portion of the ionosphere. In some examples, system 100 includes a single antenna configured to receive both direct and reflected signals. In some examples, the system 100 includes multiple antennas configured to receive both direct and/or reflected signals. In some examples, system 100 includes one or more antennas configured to receive direct signal(s) and one or more different antennas configured to receive reflected signal(s). In some examples, the one or more antennas 104 may be positioned in a dual polarized configuration to enable broadcast/transmission in one polarization and reception in other polarizations. In some examples, system 100 includes an array of dual polarized antennas 104. In some examples, the one or more antennas 104 may be deployable from the satellite (e.g., stored in a body of the satellite and deployed during transmission and reception).

In some examples the one or more processors 108 are configured to execute computer instructions stored in a memory 112 of system 100. The one or more processors may be configured to execute computer instructions for determining electron density, TEC, and/or EDP of a portion of the ionosphere based on one or more characteristics of a received direct and/or reflected signal. The computer instructions may cause the system 100 to process one or more signals received from a ground-based transmitter to determine the electron density, TEC, and/or EDP of the portion of the ionosphere. The ground-based transmitter may be configured to transmit a signal into the ionosphere. In some examples, the transmitted signal is a swept signal including a plurality of different frequencies in the high-frequency range (e.g., between 3 MHz and 30 MHZ). The at least one receiver 102 may receive the signal directly (e.g., using antenna 104) from the ground-based transmitter through a portion of the ionosphere between the satellite on which the receiver 102 is positioned and the ground-based transmitter. The signal received directly may be referred to herein as a direct signal or direct ray. The at least one receiver 102 may additionally receive a reflection of the signal (e.g., using antenna 104) from a portion of the ionosphere above the satellite. The reflection of the signal may be referred to herein as a reflected signal or reflected ray.

The one or more processors 106 may be configured to monitor and determine various characteristics of the received direct and reflected signal and store those characteristics in memory 108. For example, the at least one processor may be configured to record a time at which the direct signal and the reflected signal are received at receiver 102. In some examples, the one or more processors 106 may be configured to record a time at which each frequency of a swept signal that includes a plurality of different frequencies are received at the receiver for both the direct and reflected signal. The respective frequencies of the swept signal (direct and reflected) may be stored in memory 108 in association with the time at which they were received. In some examples, the at least one processor may be configured to determine other characteristics of the received reflected and direct signal, such as wavelength, phase, amplitude, and so on. Such characteristics may also be stored in memory 108 in association with the respective frequency of the swept direct or reflected signal to which they correspond.

In some examples, the computer instructions stored in memory 108 cause the one or more processors 106 to determine an electron density and/or electron density profile (EDP) of a portion of the ionosphere above the satellite and a total electron content of a portion of the ionosphere below the satellite between the satellite and ground-based transmitter. The electron density of the portion of the ionosphere above the satellite may be determined by computing a virtual height between the satellite and an altitude at which the signal reflected by the ionosphere and inverting the virtual height to determine the electron density as a function of altitude. The virtual height is computed by multiplying one half of an amount of time between receiving the direct signal and receiving the reflection of the signal by the speed of light. The virtual height may be inverted according to any known inversion function. The electron density profile may be determined by determining an electron density at a plurality of altitudes above the satellite. The electron density may be determined at a plurality of altitudes by computing a virtual height corresponding to the reflection point of each frequency of a swept signal (e.g., a plurality of frequencies between 3 MHz and 30 MHz) and inverting each respective virtual height to determine a plurality of electron density measurements corresponding to the different altitude at which a given frequency is reflected by the ionosphere.

An exemplary inversion function that may be utilized to determine electron density and/or electron density profile is a polynomial analysis (POLAN) inversion function, as described in Titheridge, J. E., Ionogram analysis with the generalised program POLAN (1985), which is incorporated herein by reference in its entirety. For instance, an input to POLAN or other inversion function including an array of frequencies and an array of virtual heights, may provide an output EDP. The EDP may include an electron density for each virtual height/frequency pair. For example, an array of 30 frequencies and 30 corresponding virtual heights may enable characterization of an EDP with 30 electron densities and 30 altitudes. It should be understood that additional or fewer input values can be utilized to generate an EDP with additional or fewer electron densities and corresponding altitudes. POLAN or any other inversion function can also be used to determine as few as a single electron density/altitude pair based on a single frequency/virtual height pair.

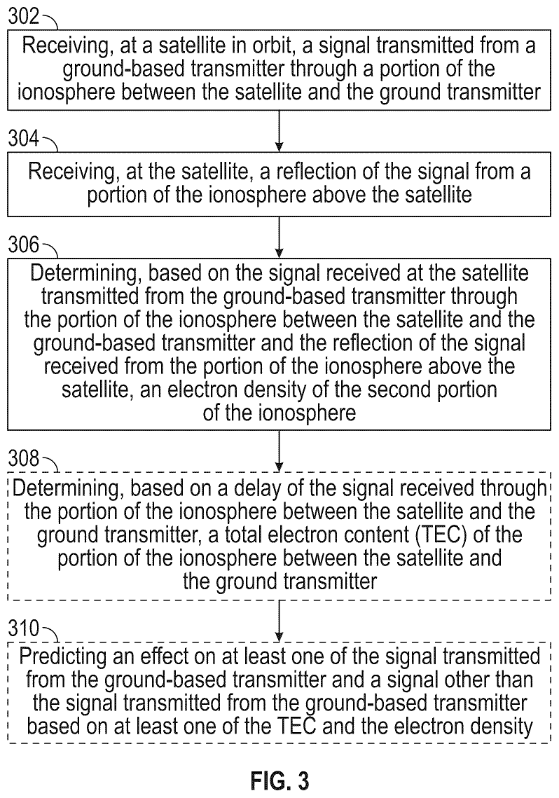

In some examples, the computer instructions stored in memory 108 may cause the one or more processors 106 to determine the total electron content (TEC) of a portion of the ionosphere between the ground-based transmitter and the satellite. TEC may be determined based a delay of the signal received from the ground-based transmitter through the portion of the ionosphere between the ground-based transmitter and the satellite. The delay may be determined according to any of a variety of known methods for determining delay of a signal propagating through the ionosphere. In some examples, system 100 may be configured to quantify effects of any one or more of off-vertical transmission geometry, doppler shift, non-specular reflection and earth's magnetic field on the signal and the reflection of the signal and compensate for those effects in determining any of TEC, electron density, or an EDP of the portion of the ionosphere, as described in additional detail with reference to FIGS. 3-5B.

In some examples, system 100 may be configured (e.g., using computer instructions stored in memory 108 to be executed by the one or more processors 106) to predict an effect on at least one of the signal transmitted from the ground-based transmitter and/or a signal other than the signal transmitted from the ground-based transmitter based on at least one of the TEC and the EDP. For instance, system 100 may be configured to predict a signal reflection, scatter, refraction, diffraction, or other signal degradation resulting from ionospheric electron content/electron density. In some examples, system 100 may be configured to adjust a characteristic of at least one of a signal transmitted from the ground-based transmitter and/or a signal other than the signal transmitted from the ground-based transmitter based on the predicted effect, wherein the characteristic comprises at least one of a frequency, a wavelength, an amplitude, a polarization, a transmission power, and a bandwidth. In some examples, the system 100 may be configured to generate a model of at least a portion of the ionosphere based on the electron density, EDP, and/or TEC of the portion of the ionosphere.

As noted above, the system 100 may be positioned in very low earth orbit (VLEO) within a portion of the ionosphere. In some examples, the portion of the ionosphere between the satellite hosting at least a portion of the components of system 100 and the ground-based transmitter includes at least one of a portion of the E layer of the ionosphere and a portion of the F layer of the ionosphere. In some examples, the portion of the ionosphere above the satellite includes a portion of the F layer of the ionosphere.

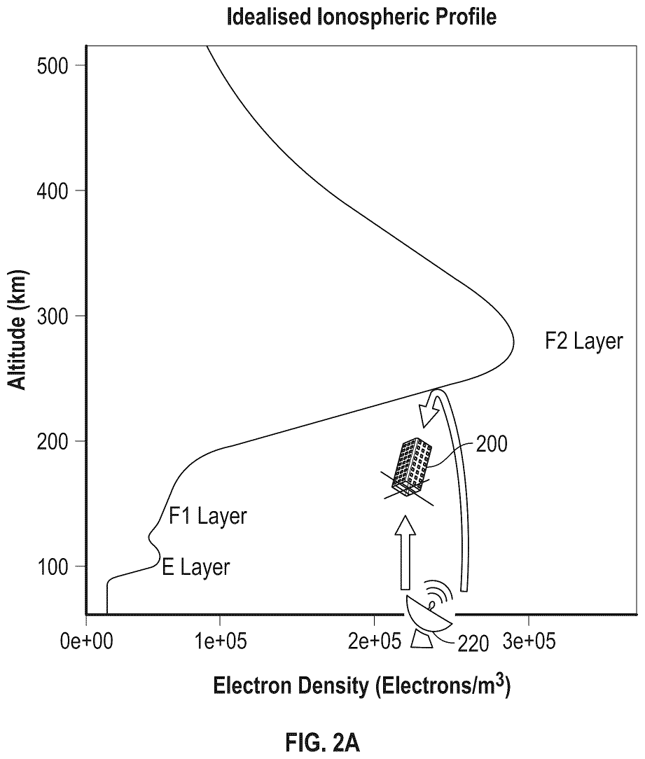

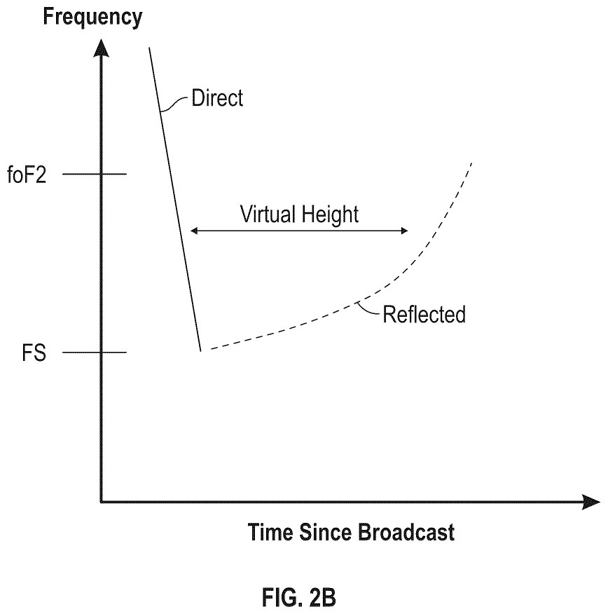

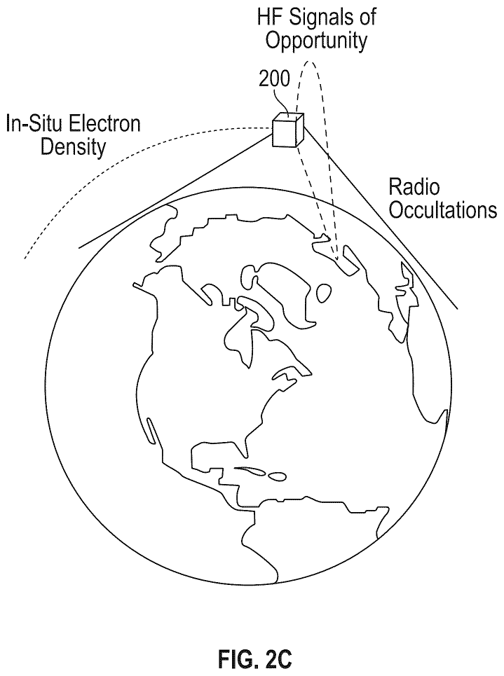

FIG. 2A illustrates an exemplary satellite system 200 for determining electron density, TEC, and/or an EDP of a portion of the ionosphere and an ionospheric profile that depicts approximate electron density by altitude. As illustrated, system 200 may be positioned in orbit within the ionosphere between roughly 100 km and 300 km. In some examples, the system is positioned above at least a portion of the F1 layer of the ionosphere and below at least a portion of the F2 layer of the ionosphere. In some examples, satellite system 200 is positioned below a peak electron density of the F2 layer of the ionosphere. System 200 may include any of the components of system 100 described above. Also depicted is a ground-based transmitter 220 configured to transmit one or more high-frequency RF signals (e.g., between 3 MHz and 30 MHz) into the ionosphere and toward satellite system 200. The ground-based transmitter 220 may be an ionosonde. In some examples, the satellite system 200 may be configured to receive signals transmitted from anywhere on a surface of a planet. In some examples, the signal transmitted from the ground-based transmitter is transmitted from less than 5,000 km from the satellite. In some examples, the signal transmitted from the ground-based transmitter is transmitted from less than 3,000 km from the satellite. In some examples, the signal transmitted from the ground-based transmitter is transmitted from at most 5000 km from the satellite, at most 4000 km from the satellite, at most 3000 km from the satellite, at most 2000 km from the satellite, at most 1000 km from the satellite, at most 500 km from the satellite, at most 400 km from the satellite, at most 300 km from the satellite, at most 200 km from the satellite, and/or at most 150 km from the satellite.

The ground-based transmitter may transmit a signal through a portion of the ionosphere below the satellite (e.g., between the satellite and the transmitter), and the signal may be received directly by the satellite (the direct signal described above). The signal may also propagate through a portion of the ionosphere above the satellite and eventually be reflected by the ionosphere (at an altitude corresponding to signal characteristics such as frequency, and ionospheric characteristics such as electron density) back down to the satellite (the reflected signal described above), as shown. The reflected signal at a respective frequency may be received by the satellite system 200 at a time after the direct signal at the same frequency is received. In some examples, the signal transmitted by the ground-based transmitter is a swept signal that includes a plurality of different frequencies between 3-30 MHz. The frequency transmitted may be varied as a function of time. For instance, at a first time the signal may be transmitted at 3 MHz and at a second time, the signal may be transmitted at 4 MHz, and so on. The direct signal at each frequency may be received prior to receipt of a corresponding reflection of the signal at the same frequency from a portion of the ionosphere above the satellite. In some examples, system 200 receives a transmission schedule including the frequencies and waveform to be included in the swept signal, along with a time of transmission for reach of the respective frequencies, prior to receiving the direct and/or reflected signal. In some examples, the transmission schedule is stored in a memory (e.g., memory 108).

Satellite system 200 may be configured to determine an electron density, TEC, and/or an EDP of one or more portions of the ionosphere based on the received signal (direct and/or reflected). For instance, satellite system 200 may be configured to determine an electron density of a portion of the ionosphere above the satellite based on a virtual height (between the satellite and the point of reflection of the reflected signal) corresponding to an amount of time between receipt of the direct and reflected signal at a respective frequency. The satellite system 200 may be configured to compute the virtual height between the satellite and the point of reflection of the reflected signal (e.g., the altitude at which the signal is reflected by the ionosphere) and invert the virtual height to determine the electron density at the point of reflection. The virtual height may be determined by multiplying one half of an amount of time between receiving the signal and receiving the reflection of the signal by the speed of light. The virtual height may be inverted to determine electron density at the reflection point using any known inversion function for determining electron density. For a single frequency/virtual height pair input, an inversion function ma provide a single electron density/true height pair. For an input array of frequencies stretching from the local plasma frequency and foF2, and the virtual heights that they correspond to, an inversion function may provide the EDP between the satellite and hmF2.

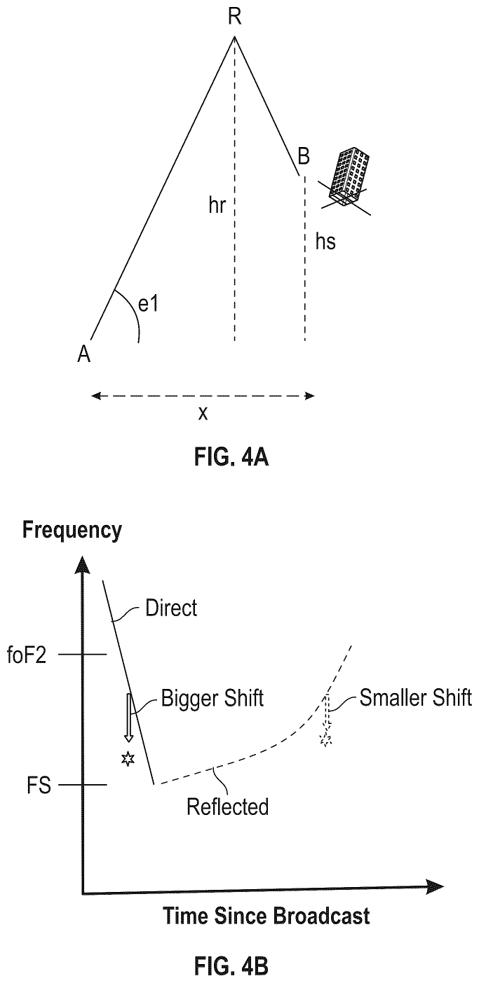

Satellite system 200 may be configured to determine the virtual height for each frequency of the swept signal. For each frequency of the plurality of frequencies, system 200 may determine virtual height between the satellite and an altitude at which the respective frequency was reflected by the ionosphere. The system may then invert virtual height to determine the electron density at the altitude at which the respective frequency was reflected. Each frequency is reflected at a different altitude. For instance, higher frequency portions of the swept signal propagate further into the ionosphere above the satellite than lower frequency portions of the signal due at least in part to increasing electron density at higher altitudes within the ionosphere up to the peak electron density within the F2 layer. As illustrated in FIG. 2B, the virtual height may increase as the frequency of the transmitted signal increases, resulting in different electron density measurements at each frequency. Using a swept signal including a plurality of frequencies in the high frequency range, the system can probe different portions of the ionosphere for electron density to develop an electron density profile (EDP) across a range of altitudes above the satellite. In other words, as noted above, for a single frequency and corresponding virtual height pair, a single electron density and corresponding true height pair can be determined. Using an array of frequencies stretching from the local plasma frequency and foF2 (shown in FIG. 4B and discussed below), and the virtual heights that those frequencies correspond to, the EDP above the satellite can be determined.

FIG. 2C illustrates satellite system 200 in an exemplary environment depicting distinctions between the measurements obtainable using satellite system 200 compared to those obtainable using radio occultations (e.g., transmitted to satellite 200 via a GNSS-RO satellite). As illustrated, radio occultations (RO) can provide valuable information about the ionosphere (e.g., TEC, electron density). However, RO measurements cannot provide information about TEC or electron density in portions of the ionosphere located below a satellite in orbit receiving the RO signals, resulting in measurement blind spots. These blind spots are apparent in FIG. 2C. The systems and methods disclosed herein can characterize the ionosphere both below the satellite by determining TEC in a portion of the ionosphere between a ground-based transmitter and both TEC and electron density in in a portion of the ionosphere above the satellite. Moreover, the systems and methods described herein provide ionospheric data in regions of the ionosphere not obtainable using conventional measurements obtained using ionosondes and/or GNSS ground stations—including measurements over open oceans where the satellite has a line of sight to the HF transmitter.

FIG. 3 illustrates an exemplary process 300 for determining electron density, TEC, and/or an EDP of one or more portions of the ionosphere. In some examples, process 300 may be performed using one or more components of system 100 described above. Process 300 is performed, for example, using one or more electronic devices implementing a software platform. In some examples, process 300 is performed using one or more electronic devices. In some embodiments, process 300 is performed using a client-server system, and the blocks of process 300 are divided up in any manner between the server and one or more client devices. Thus, while portions of process 300 are described herein as being performed by particular devices, it will be appreciated that process 300 is not so limited. In process 300, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

At block 302, the process 300 may include receiving, at a satellite in orbit, a signal transmitted from a ground-based transmitter through a portion of the ionosphere between the satellite and the ground transmitter. The satellite may be positioned in very low earth orbit (VLEO). For instance, the satellite may be positioned in orbit between 100 km and 450 km above a surface of the earth. In some examples, the satellite may be positioned below a height of a peak electron density of the F2 layer of the ionosphere (hmF2). The portion of the ionosphere between the satellite and the ground transmitter may include at least one of a portion of the E layer of the ionosphere and a portion of the F layer of the ionosphere. In some examples, the portion of the ionosphere between the satellite and the ground transmitter includes at least a portion of the F1 layer of the ionosphere. At block 304, the process 300 may include receiving, at the satellite, a reflection of the signal from a portion of the ionosphere above the satellite. The portion of the ionosphere above the satellite may include at least a portion of the F layer of the ionosphere. The portion of the ionosphere above the satellite may include at least a portion of the F2 layer of the ionosphere.

At block 306, the process 300 may include determining, based on the signal received at the satellite transmitted from the ground-based transmitter through the portion of the ionosphere between the satellite and the ground-based transmitter at block 302 and the reflection of the signal received from the portion of the ionosphere above the satellite at block 304, an electron density of the portion of the ionosphere above the satellite. The electron density may be determined by computing a virtual height between the satellite and an altitude at which the signal reflected by the ionosphere and inverting the virtual height to determine the electron density at the altitude. The virtual height may be computed by multiplying one half of an amount of time between the time at which the signal transmitted through the portion of the ionosphere between the satellite and the ground-based station is received at the satellite and the time at which the reflection of the signal is received by the speed of light. Any known inversion function for inverting virtual height to determine electron density may be used.

The signal transmitted from the ground-based station and received at block 302 may be a swept signal (e.g., sweep signal, chirp signal) that includes a plurality of different frequencies transmitted over a period of time. The swept signal may include a plurality of different frequencies between 3 MHz and 30 MHz. In some examples, the frequency of the swept signal is varied linearly over a predefined time period. In some examples, the time period is at least 1 second, at least 2 seconds, at least 3 seconds, at least 4 seconds, at least 5 seconds, at least 6 seconds, at least 7 seconds, at least 8 seconds, at least 9 seconds, and/or at least 10 seconds. In some examples, the time period is at most 1 second, at most 2 seconds, at most 3 seconds, at most 4 seconds, at most 5 seconds, at most 6 seconds, at most 7 seconds, at most 8 seconds, at most 9 seconds, and/or at most 10 seconds. In some examples, the time period may be significantly longer (e.g., minutes, hours, etc.).

The satellite may be positioned in orbit below the peak electron density of the F2 layer of the ionosphere. The electron density of any plasma determines its plasma frequency. The more dense a plasma is, the higher its frequency. Signals with frequencies higher than the plasma frequency will pass through the plasma, and signals with frequencies lower than the plasma frequency will be reflected. For frequencies (e.g., of the swept signal) below the plasma frequency (FS) at the satellite's altitude, no signal (direct or reflected) is received by the satellite. For frequencies between the plasma frequency (FS) at the satellite's altitude and the maximum frequency (FoF2) the satellite will receive both a direct and reflected signal, and for frequencies above the maximum frequency, the satellite will receive only a direct signal. Accordingly, the first frequency of a swept signal that the satellite will receive is FS (as a direct signal transmitted through the portion of the ionosphere between the ground-based transmitter and the satellite. The highest frequency that can be measured twice is FoF2, which enables measurement of the height of the peak electron density above the satellite, as shown in FIG. 2A.

The difference in time between receipt of the first direct signal transmitted through the portion of the ionosphere between the satellite and the ground-based transmitter at frequency FS (which may be between 3 MHz and 30 MHz) and the receipt of the first reflection of the signal at the same frequency reflected by the portion of the ionosphere above the satellite can be used to determine a first electron density above the satellite. The time between the direct and reflected signal at FS can be divided by two and multiplied by the speed of light to give the virtual height. As noted above, the virtual height is defined relative to the satellite, and can be inverted to obtain an electron density at an altitude above the satellite.

This computation may be repeated for each frequency of the swept signal. For instance, for each frequency of the plurality of frequencies, the process may include determining a virtual height between the satellite and an altitude at which the respective frequency was reflected by the ionosphere and inverting the virtual height to determine the electron density at the altitude at which the respective frequency was reflected. An electron density profile (EDP) of the portion of the ionosphere above the satellite can be determined based on the electron density computed based on each of the respective frequencies of the signal sweep. Advantageously, and unlike conventional ground-based oblique ionogram techniques, it is not necessary to know the time at which the signal was broadcast to determine the EDP because the direct signal provides a baseline for comparison to the reflection of the signal.

In some examples, at block 308, the process 300 optionally includes determining, based on a delay of the signal received through the portion of the ionosphere between the satellite and the ground transmitter, a total electron content (TEC) of the portion of the ionosphere between the satellite and the ground transmitter. The delay may be an ionospheric delay (e.g., due to dispersive effects of the ionosphere) and may be determined according to any known method for determining ionospheric delay of a signal propagating through the ionosphere. For instance, TEC may be determined based on a phase delay and/or group delay of the received signal at one or more frequencies.

As an example, ignoring the magnetic field, a virtual height between the ground-based transmitter and the satellite (e.g., the direct ray virtual height) can be computed as a function of the frequency of the signal using the equations below, where h′ is the direct ray virtual height.

$$X ≡ {f}_{N}^{2} / {f}^{2} \\ {μ}^{′} = \frac{1 - x + {x}^{2}}{{( 1 - x )}^{3 / 2}} \\ {h}^{′} = {h}_{b} + {\int }_{{h}_{b}}^{{h}_{s}} \frac{1 - x + {x}^{2}}{{( 1 - x )}^{3 / 2}} dh \qquad ( 1 )$$

In the equations above, X is a function of f and f_{N}, where f is the frequency of the signal received at the satellite, f_{N} is the plasma frequency (FS, described above), and μ′ is the refractive index, which is a function of X.

When f>f_{N}, then X<1, equation (1) can be Taylor expanded so that μ′ can be approximated as 1+x/2, resulting in:

$$\begin{matrix}{h}^{′} = {h}_{b} + {\int }_{{h}_{b}}^{{h}_{s}} 1 + x / 2 dh \\ = {h}_{b} + {\int }_{{h}_{b}}^{{h}_{s}} 1 + {f}_{N}^{2} / 2 {f}^{2} dh \\ = {h}_{s} + \frac{1}{2 {f}^{2}} {\int }_{{h}_{b}}^{{h}_{r}} {f}_{n}^{2} ( h ) dh \\ = {h}_{s} + \frac{α}{2 {f}^{2}} {\int }_{{h}_{b}}^{{h}_{r}} {N}_{e} ( h ) dh = {h}_{s} + \frac{α}{2 {f}^{2}} TEC\end{matrix} \qquad ( 2 )$$

where hₛ is the satellite altitude, h_{b} is the altitude of the bottom of the ionosphere, and α is used to convert the plasma frequency f_{N} to electron density Nₑ using the equation f_{N}²=α*Nₑ. Equation (2) can be used to determine TEC in the portion of the ionosphere between the ground-based transmitter and the satellite.

The equations above do not account for the effects of the magnetic field, doppler effect (movement of the satellite in orbit), and other factors on TEC. In some examples, the effects of the magnetic field, doppler effect, and off-vertical signal transmission can be determined and compensated for in determining TEC below the satellite and/or electron density above the satellite.

In some examples, determining at least one of the TEC and the electron density includes determining an impact of a doppler shift on the signal and the reflection of the signal and compensating for the impact of a doppler shift in determining TEC and/or electron density. The satellite will be moving in orbit relative to the ground-based transmitter. The movement can result in a change in the observed frequency of the transmitted/reflected signals. In such cases, it may be desirable to account for that movement in determining at least one of the TEC and the electron density. Effect of the doppler shift on apparent frequency can be computed by:

$$Δ f = \sqrt{\frac{c - v}{c + v}} f$$

where f is the frequency, c is the speed of light, and v is the velocity of the satellite. For a satellite moving at, for example, 10 km/s, and a frequency between 1 and 10 MHz, the doppler effect may be between 30 and 300 Hz.

In some examples, determining at least one of the TEC and the electron density includes determining an impact of an off-vertical geometry between the ground-based transmitter and the satellite and compensating for the off-vertical geometry in determining TEC and/or electron density. The elevation angle of the ray is zero when the ray is moving horizontally, and 90 degrees when the ray is moving vertically. The equivalent vertical frequency (EVF) of an off-vertical ray is computed by multiplying the actual frequency by the sine of the elevation angle. The EVF is lower than the actual frequency and determines where the ray reflects. For example, a ray with an elevation angle of 30 degrees and an actual frequency of 10 MHz has an EVF of 5 MHz. This ray can be reflected by an ionosphere with a maximum plasma frequency below 10 MHz because of this effect. This effect is important because the elevation angles are different for the direct and reflected path, so these two paths have different EVFs. The signal received at the satellite transmitted from the ground-based transmitter through the portion of the ionosphere between the satellite and the ground-based transmitter (the direct ray) will have a smaller elevation angle and thus a lower EVF. The reflection of the signal from the portion of the ionosphere above the satellite (the reflected ray) will have a higher elevation angle and therefore a higher apparent EVF than the direct ray. This matters because the virtual height is computed by comparing the times of arrivals for the direct and reflected paths with equivalent EVFs, not equivalent actual frequencies.

FIG. 4A illustrates an exemplary orientation of a ground-based transmitter (at location A) and a satellite (at location B) in which signals are transmitted between the ground-based transmitter and the satellite at an off-vertical geometry. As depicted, the satellite altitude is represented by hₛ, the reflection height is represented by hᵣ, the location of the ground-based transmitter is represented by A, the location of the satellite is represented by B, and the reflection point location is represented by R. The angle e1 between the path traveled by the signal between A and R can be computed according to the following equation:

$${e}_{1} = tan ( \frac{2 {h}_{r} - {h}_{s}}{x} )$$

where x is the horizontal distance between A and B. The angle e2 between the path traveled by the signal between A and B can be computed according to the following equation:

$${e}_{2} = tan ( \frac{{h}_{s}}{x} )$$

The length of the path traveled by the reflected signal between points A, R, and B, can be computed according to the following equation, where e is e₁ above:

$$ARB = \frac{2 {h}_{r} - {h}_{s}}{sin ( e )}$$

The length of the path between A and B traveled by the signal transmitted between the ground-based transmitter and the satellite through the portion of the ionosphere below the satellite (the direct ray) can be computed according to the following equation:

$$AB = \sqrt{{h}_{s}^{2} + {x}^{2}}$$

The effect of the off-vertical transmission geometry on the frequencies of the direct and reflected rays is illustrated in FIG. 4B. As depicted, the direct ray has a lower EVF than the reflected ray.

In some examples, determining at least one of the TEC and the electron density includes using ray tracing to quantify an impact of at least one of non-specular reflection and earth's magnetic field on the signal and the reflection of the signal. For instance, the O and X mode can be separated from the received direct and reflected signals to quantify and compensate for an impact of the magnetic field on TEC and electron density determinations. The analytical methods described above assumed that the transmitted frequency was larger than the plasma frequency which allowed a Taylor expansion. Ray tracing is a tool that can relax this assumption and add more accuracy to predictions especially for situations where the signal frequency is close to the plasma frequency.

Returning to FIG. 3, at block 310, the process 300 optionally includes predicting an effect (e.g., reflection, refraction, scattering, etc.) on at least one of the signal transmitted from the ground-based transmitter and a signal other than the signal transmitted from the ground-based transmitter based on at least one of the TEC and the electron density (and/or electron density profile). The process may also include adjusting a characteristic of at least one of the signal transmitted from the ground-based transmitter and the signal other than the signal transmitted from the ground-based transmitter based on the predicted effect. For instance, the adjusted characteristic may include at least one of a frequency, a wavelength, an amplitude, a polarization, a transmission power, and a bandwidth.

In some examples, the process optionally includes generating a model of at least a portion of the ionosphere base on the determined electron density, electron density profile, and/or TEC. For instance, systems use data assimilation to specify the state of the ionosphere in real time. To do this, data are combined with a background model to produce an updated forecast called an ‘analysis’. Process 300 may include combining the determined electron density, electron density profile, and/or total electron content with information obtained from a conventional GNSS based measurement, RO measurement, ionosonde measurement, etc., to obtain a more accurate three-dimensional characterization of the ionosphere's electron density than can be obtained via conventional measurements alone.

FIG. 5A illustrates a graph depicting an exemplary estimation of TEC based on measured delay of the direct signal for a plurality of different frequencies. In the depicted example, delay and frequency of the signal transmitted were known, and the unknown terms of equation (2) above are rewritten as A and B in the following equation: Fit delay=A+B*TEC/f². A, B, and TEC are unknown. A three-parameter fit was conducted, to find A, B, and TEC. The solid line of the graph of FIG. 5A illustrates the TEC resulting from the three-parameter fit. The TEC shown in FIG. 5A does not account for magnetic field effects. FIG. 5B graphs the group refractive index against frequency for no mode (no magnetic field effect), O mode, and X mode. The group refractive index is computed at each point on the path between the transmitter and receiver and then used to compute the instantaneous speed of a ray at that point. These speeds are used to compute the total travel time. This travel time is used to compute the TEC.

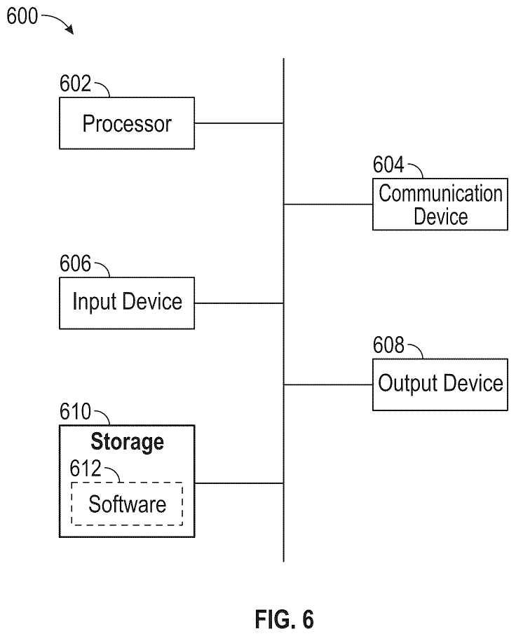

FIG. 6 depicts an exemplary computing device 600 that may be utilized in accordance with one or more examples of the disclosure (e.g., as a component of system 100) for determining electron density, TEC, and/or an electron density profile of a portion of the ionosphere. Device 600 can be a host computer connected to a network. Device 600 can be a client computer or a server. As shown in FIG. 6, device 600 can be any suitable type of microprocessor-based device, such as a personal computer, workstation, server, or handheld computing device (portable electronic device) such as a phone or tablet. The device can include, for example, one or more of processors 602, input device 606, output device 608, storage 610, and communication device 604. Input device 606 and output device 608 can generally correspond to those described above and can either be connectable or integrated with the computer.

Input device 606 can be any suitable device that provides input, such as a touch screen, keyboard or keypad, mouse, or voice-recognition device. Output device 608 can be any suitable device that provides output, such as a touch screen, haptics device, or speaker.

Storage 610 can be any suitable device that provides storage, such as an electrical, magnetic, or optical memory, including a RAM, cache, hard drive, or removable storage disk. Communication device 604 can include any suitable device capable of transmitting and receiving signals over a network, such as a network interface chip or device. The components of the computer can be connected in any suitable manner, such as via a physical bus or wirelessly.

Software 612, which can be stored in storage 610 and executed by processor 602, can include, for example, the programming that embodies the functionality of the present disclosure (e.g., as embodied in the devices as described above).

Software 612 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 610, that can contain or store programming for use by or in connection with an instruction execution system, apparatus, or device.

Software 612 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can implement any operating system suitable for operating on the network. Software 612 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for determining an electron density in a portion of an ionosphere comprising:
receiving, at a satellite in orbit, a signal transmitted from a ground-based transmitter through a portion of the ionosphere between the satellite and the ground transmitter;
receiving, at the satellite, a reflection of the signal from a portion of the ionosphere above the satellite; and
determining, based on the signal received at the satellite transmitted from the ground-based transmitter through the portion of the ionosphere between the satellite and the ground-based transmitter and the reflection of the signal received from the portion of the ionosphere above the satellite, an electron density of the portion of the ionosphere above the satellite.

2. The method of claim 1, wherein the electron density of the portion of the ionosphere above the satellite is determined by:
computing a virtual height between the satellite and an altitude at which the signal reflected by the ionosphere; and
inverting the virtual height to determine the electron density at the altitude.

3. The method of claim 2, wherein the virtual height is computed by multiplying one half of an amount of time between receiving the signal and receiving the reflection of the signal by the speed of light.

4. The method of claim 1, comprising: determining, based on a delay of the signal received through the portion of the ionosphere between the satellite and the ground transmitter, a total electron content (TEC) of the portion of the ionosphere between the satellite and the ground transmitter.

5. The method of claim 4, wherein determining at least one of the TEC and the electron density comprises using ray tracing to quantify an impact of at least one of non-specular reflection and earth's magnetic field on the signal and the reflection of the signal.

6. The method of claim 4, wherein determining at least one of the TEC and the electron density comprises determining an impact of a doppler shift on the signal and the reflection of the signal.

7. The method of claim 1, wherein the signal comprises a plurality of frequencies between 3 and 30 MHz transmitted over a period of time.

8. The method of claim 7, comprising: for each frequency of the plurality of frequencies, determining a virtual height between the satellite and an altitude at which the respective frequency was reflected by the ionosphere; and inverting the virtual height to determine the electron density at the altitude at which the respective frequency was reflected.

9. The method of claim 8, comprising: determining an electron density profile (EDP) based on the electron density determined for each frequency.

10. The method of claim 1, wherein the portion of the ionosphere between the satellite and the ground-based transmitter comprises at least one of a portion of the E layer of the ionosphere and a portion of the F layer of the ionosphere.

11. The method of claim 1, wherein the portion of the ionosphere above the satellite comprises a portion of the F layer of the ionosphere.

12. The method of claim 1, wherein the satellite is positioned in very low earth orbit (VLEO).

13. The method of claim 1, wherein the satellite is positioned below a height of a peak electron density of the F2 layer of the ionosphere.

14. The method of claim 1, wherein the signal transmitted from the ground-based transmitter is transmitted from less than 5,000 km from the satellite.

15. The method of claim 1, comprising: predicting an effect on at least one of the signal transmitted from the ground-based transmitter and a signal other than the signal transmitted from the ground-based transmitter based on at least one of the TEC and the EDP.

16. The method of claim 15, comprising: adjusting a characteristic of at least one of the signal transmitted from the ground-based transmitter and the signal other than the signal transmitted from the ground-based transmitter based on the predicted effect, wherein the characteristic comprises at least one of a frequency, a wavelength, an amplitude, a polarization, a transmission power, and a bandwidth.

17. The method of claim 1, comprising: generating a model of at least a portion of the ionosphere based on the electron density.

18. The method of claim 1, comprising: transmitting the signal from the ground-based transmitter.

19. A non-transitory computer readable storage medium storing instructions for determining an electron density in a portion of an ionosphere wherein the instructions are executable by a system comprising one or more processors to cause the system to:
receive, at a satellite in orbit, a signal transmitted from a ground-based transmitter through a portion of the ionosphere between the satellite and the ground transmitter;
receive, at the satellite, a reflection of the signal from a portion of the ionosphere above the satellite; and
determine, based on the signal received at the satellite transmitted from the ground-based transmitter through the portion of the ionosphere between the satellite and the ground-based transmitter and the reflection of the signal received from the portion of the ionosphere above the satellite, an electron density of the portion of the ionosphere above the satellite.

20. A system comprising:
a satellite;
at least one receiver positioned on the satellite; and
one or more processors and a memory, the memory storing one or more computer programs that include computer instructions, which when executed by the one or more processors, cause the system to:
determine, based on a signal received at the receiver positioned on the satellite, the signal transmitted from a ground-based transmitter through a portion of the ionosphere between the satellite and the ground-based transmitter, and a reflection of the signal received from a portion of the ionosphere above the satellite, an electron density of the portion of the ionosphere above the satellite.

21. The system of claim 20, wherein the one or more processors are located at a ground station.

22. The system of claim 20, wherein the one or more processors are positioned on the satellite.

23. The system of claim 20, wherein the ground-based transmitter comprises an ionosonde.
